(19) United States
(12) Patent Application Publication
(10) Pub. No.: US 2024/0006171 A1
(43) Pub. Date: Jan. 4, 2024

(54) QUADRUPOLE MASS SPECTROMETER AND RESIDUAL GAS ANALYSIS METHOD

(71) Applicant: HORIBA STEC, Co., Ltd., Kyoto (JP)

(72) Inventor: Hiroshi TAKAKURA, Kyoto (JP)

(73) Assignee: HORIBA STEC, Co., Ltd., Kyoto (JP)

(21) Appl. No.: 18/039,574

(22) PCT Filed: Oct. 13, 2021
(86) PCT No.: PCT/JP2021/037836

§ 371 Date: May 31, 2023

(30) Foreign Application Priority Data
Dec. 7, 2020 (JP) 2020-202839

(51) Int. Cl. H01J 49/02; H01J 49/42; H01F 30/16; H01F 27/28; H01F 27/22; H01J 49/04

(52) U.S. Cl. CPC H01J 49/022; H01J 49/4225; H01F 30/16; H01F 27/2895; H01F 27/2852; H01F 27/22; H01J 49/0422; H01F 2027/065

(57) ABSTRACT

The present invention is aimed to provide a quadrupole mass spectrometer that is less thermally affected by a transformer, the quadrupole mass spectrometer including: an ionizer unit that ionizes a sample; a quadrupole unit that has two pairs of opposing electrodes that selectively pass ions generated in the ionizer unit; a voltage applying unit that applies a voltage obtained by superimposing a high-frequency voltage V cos ωt over a DC voltage U and to each pair of the two pairs of opposing electrodes; and an ion detecting unit that detects ions having passed through the quadrupole unit, wherein the voltage applying unit includes the transformer that transforms the high-frequency voltage V cos ωt, and the transformer includes a toroidal core, and a primary winding and a secondary winding that are wound around the toroidal core, and the primary winding is formed of a metal conductor having a plate-like shaped.

### TECHNICAL FIELD

The present invention relates to a quadrupole mass spectrometer and a residual gas analysis method.

### BACKGROUND ART

Conventionally, as disclosed in Patent Literature 1, a quadrupole mass spectrometer includes a quadrupole unit that selectively passes ions. In the quadrupole unit, a voltage with a high-frequency voltage superimposed over a DC voltage is applied to each pair of two pairs of opposing electrodes. Before this high-frequency voltage is applied to the opposing electrodes, the high-frequency voltage is boosted by a transformer.

### CITATION LIST

### Patent Literature

Patent Literature 1: JP 2011-249172 A

### SUMMARY OF THE INVENTION

### Technical Problem

The inventor of the present invention disclosed in the present application continuously measured a specific mass-to-charge ratio (m/z=40 AMU) over a predetermined time period using the quadrupole mass spectrometer described above. However, it becomes clear that, as the time elapses, the peak of the output current had drifted, and this drift led to a measurement error, as illustrated in FIG. 9. As a result of intensive exploration for a cause, it has been found that the heat generated by the transformer was thermally affecting the circuit components on a circuit board nearby.

Therefore, the present invention has been made to solve the above problem, and a main object of the present invention is to reduce the thermal effect of a transformer for transforming a high-frequency voltage in a quadrupole mass spectrometer.

### Solution to Problem

In other words, a quadrupole mass spectrometer according to the present invention includes: an ionizer unit that ionizes a sample; a quadrupole unit that has two pairs of opposing electrodes selectively passing ions generated in the ionizer unit; a voltage applying unit that applies a voltage obtained by superimposing a high-frequency voltage over a DC voltage to each pair of the two pairs of opposing electrodes; and an ion detecting unit that detects the ions having passed through the quadrupole unit, wherein the voltage applying unit includes a transformer that transforms a high-frequency voltage, the transformer includes a toroidal core, and a primary winding and a secondary winding that are wound around the toroidal core, and the primary winding is formed of a metal conductor having a plate-like shape.

With such a quadrupole mass spectrometer, because the transformer includes the toroidal core, and the primary winding and the secondary winding that are wound around the toroidal core, and because the primary winding of the transformer is formed of a metal conductor having a plate-like shape, it is possible to increase the effective cross-sectional area of the primary winding through which the high-frequency current flows. As a result, it becomes possible to reduce a thermal loss in the primary winding, so that it is possible to reduce the thermal effect attributable to the transformer. In addition, because the primary winding is formed of a plate-shaped metal conductor, it is possible to reduce the number of turns required in the primary winding. Therefore, it is possible to simplify the winding work, so that it becomes possible to improve the productivity.

As a specific embodiment of the secondary winding to be wound around the toroidal core, the secondary winding may include: a first secondary winding connected to one pair of the two pairs of opposing electrodes; and a second secondary winding connected to the other pair of the two pairs of opposing electrodes.

In the present invention, a metal conductor having a plate-like shape is used to form radial current paths through the primary winding. Therefore, it is possible to reduce variation of the magnetic coupling between the primary winding and the first secondary winding, and the magnetic coupling between the primary winding and the second secondary winding. Hence, it is possible to reduce variation in the output high-frequency voltage.

In order to increase a cross-sectional area of the transformer to increase the allowable magnetic flux, while reducing the footprint of the transformer (specifically, a mounting area of the high-frequency circuit board), so as to reduce the loss (core loss) and the heat generation in the toroidal core, the toroidal core is preferably configured as a stack of two or more toroidal core elements.

The primary winding is preferably wound radially around the toroidal core.

With this configuration, it is possible to increase the cross-sectional area of the plate-like metal conductor that is the primary winding, so that the advantageous effects achieved by the present invention can be made even more prominent.

As a specific embodiment of the primary winding, the primary winding may have a plurality of belt-shaped portions that are radially arranged in a development view, and the plurality of belt-shaped portions may be wound around the toroidal core.

With this configuration, the work of winding the primary windings radially can be simplified.

As another specific embodiment of the primary winding, the primary winding preferably includes: a base plate that is provided with a metal conductor on one surface; a center pin member that is made of a metal conductor, and that is connected to a central portion of the base plate and is disposed at a center of the toroidal core; and a plurality of peripheral pin members that are made of a metal conductor, and that are connected to peripheral portions of the base plate and are disposed around the toroidal core.

With this configuration, the primary winding can be assembled easily.

In the toroidal core that is an iron core, core loss may be a cause of heat generation. In order to enable the toroidal core to efficiently dissipate heat to the outside, a space between the toroidal core and the primary winding is preferably filled with an adhesive that is thermally conductive.

In order to simplify the configuration for fixing the transformer to the circuit board and to enable the dissipation of heat generated by the primary winding via the circuit board to the outside, the transformer is preferably fixed to the circuit board by fixing the primary winding to the circuit board.

By further including a control unit that controls the voltage applying unit according to the present invention, and causing the control unit to control the voltage applying unit to measure a specific mass-to-charge ratio continuously over a predetermined time period, the advantageous effects achieved by the present invention can be made more prominent.

Furthermore, a residual gas analysis method according to the present invention is characterized in analyzing the residual gas inside a vacuum chamber using the quadrupole mass spectrometer described above.

### Advantageous Effects of Invention

According to the present invention described above, it is possible to reduce the thermal effect of a transformer in a quadrupole mass spectrometer.

### BRIEF DESCRIPTION OF THE DRAWINGS

FIG. 1 is a schematic view illustrating a quadrupole mass spectrometer according to an embodiment of the present invention, in a manner attached to a vacuum chamber.

FIG. 2 is a view schematically illustrating a configuration of the quadrupole mass spectrometer according to the embodiment.

FIG. 3 is a perspective view schematically illustrating structures including a quadrupole unit according to the embodiment.

FIG. 4 is a cross-sectional view illustrating a configuration of a transformer according to the embodiment.

FIG. 5 is a plan view illustrating a configuration of the transformer according to the embodiment.

FIG. 6 is an exploded perspective view of the transformer according to the embodiment.

FIG. 7 is a diagram illustrating a high-frequency power supply circuit included in the transformer according to the embodiment, and a conventional high-frequency power supply circuit.

FIG. 8 is a diagram illustrating experimental results, in temperatures, on the heat generated in the transformer having the conventional structure, and in the transformer according to the present embodiment.

FIG. 9 is a diagram illustrating measurement results of the specific mass-to-charge ratio (m/z=40 AMU) measured continuously over a predetermined time period using a conventional quadrupole mass spectrometer.

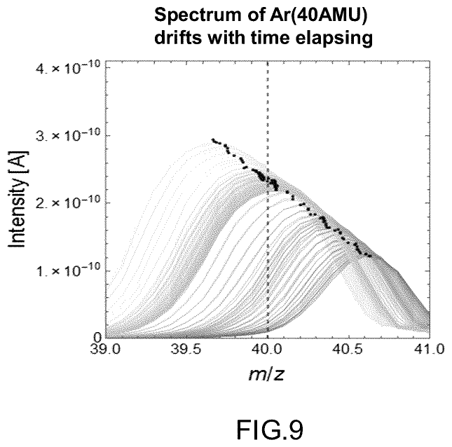

FIG. 10 is a cross-sectional view illustrating a configuration of a transformer according to a modification.

### REFERENCE SIGNS LIST

100 quadrupole mass spectrometer
VC vacuum chamber
21 ionizer unit
23 quadrupole unit
24 ion detector
23P opposing electrodes
32 voltage applying unit
33 control unit
4 transformer
41 toroidal core
41a, 41b toroidal core element
42 primary winding
43a first secondary winding
43b second secondary winding
421 belt-shaped portion
44 adhesive
5 high-frequency circuit board

### DESCRIPTION OF EMBODIMENT

A quadrupole mass spectrometer according to an embodiment of the present invention will now be explained with reference to some drawings.

<1. Overall Configuration>

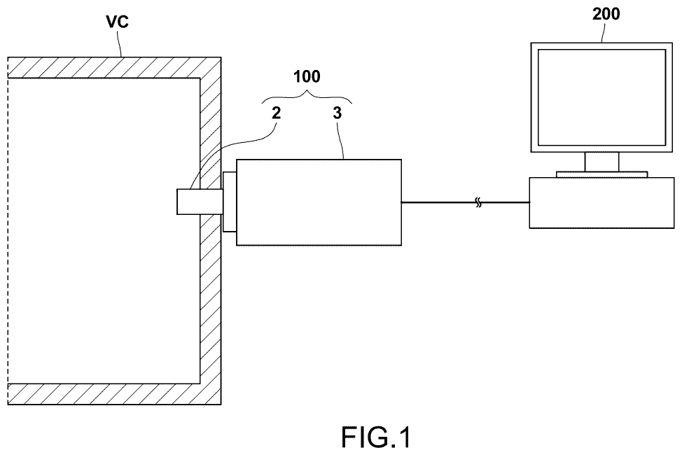

This quadrupole mass spectrometer 100 according to the present embodiment is used in monitoring gas inside a vacuum chamber VC during a semiconductor manufacturing process or after the equipment is cleaned, for example, in a manner attached to the vacuum chamber VC, as illustrated in FIG. 1, to analyze the residual gas that is a sample gas inside the vacuum chamber VC.

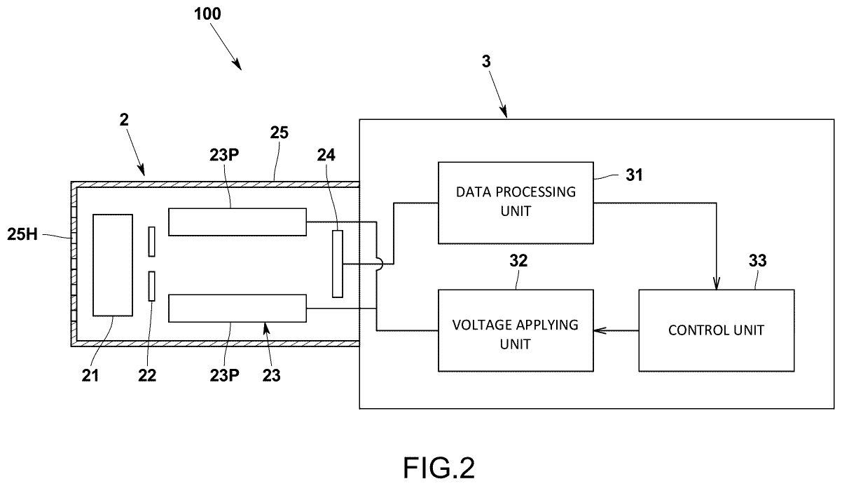

Specifically, as illustrated in FIGS. 1 and 2, the quadrupole mass spectrometer 100 includes a sensor unit 2 that detects a sample gas such as a process gas or a residual gas inside the vacuum chamber VC, and a calculating unit 3 that controls the sensor unit 2 and performs processing such as residual gas analysis, based on the output from the sensor unit 2.

As illustrated in FIG. 2, the sensor unit 2 includes an ionizer unit 21 that ionizes residual gas that is sample gas, an ion extraction electrode 22 that is provided outside the ionizer unit 21 and extracts ions, a quadrupole unit 23 that selectively passes the ions extracted from the ionizer unit 21, being extracted by the ion extraction electrode 22, and an ion detecting unit 24 that detects the ions having passed through the quadrupole unit 23.

Note that the sensor unit 2 includes a casing 25 that encloses and protects the ionizer unit 21, the ion extraction electrode 22, the quadrupole unit 23, and the ion detecting unit 24 in the order listed herein from the side of a tip end. In the casing 25, the ionizer unit 21, the ion extraction electrode 22, the quadrupole unit 23, and the ion detecting unit 24 are arranged along a straight line. A gas inlet 25H is provided on the wall of the tip end of the casing 25, so that, when the sensor unit 2 is attached to the vacuum chamber VC, the residual gas inside the vacuum chamber VC is guided inside the sensor unit 2. The casing 25 is air-tightly attached to an attachment hole provided in the vacuum chamber VC, with a seal member or the like interposed therebetween. The gas inlet 25H serves to equalize the pressure inside the casing 25 to the pressure inside the vacuum chamber VC. As a result, the ionizer unit 21, the ion extraction electrode 22, the quadrupole unit 23, and the ion detecting unit 24 are exposed to the internal pressure of the vacuum chamber VC.

A filament is provided inside the ionizer unit 21 so as to ionize the sample gas with thermoelectrons emitted from the filament. The ions generated inside the ionizer unit 21 are then extracted to the outside by the ion extraction electrode 22.

The ion extraction electrode 22 includes a single electrode or a plurality of electrodes. The ion extraction electrode 22 is provided between the ionizer unit 21 and the quadrupole unit 23, and is configured to extract the ions generated inside the ionizer unit 21 to the quadrupole unit 23 and the ion detecting unit 24, while accelerating and causing the ions to converge.

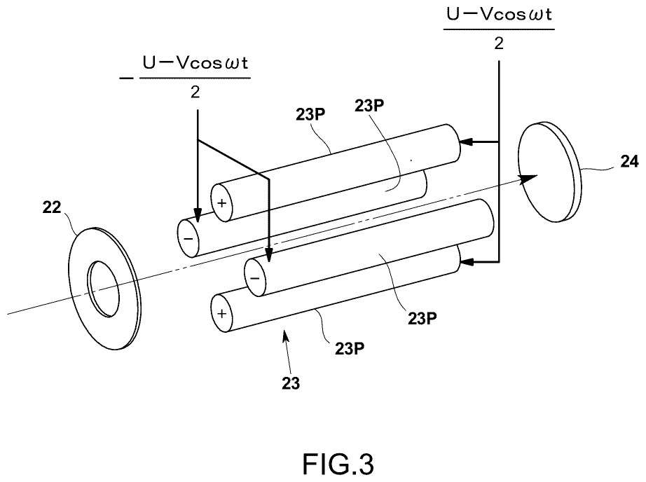

The quadrupole unit 23 separates an ion beam having been accelerated and converged by the ion extraction electrode 22, based on the mass-to-charge ratio (m/z) of the ions. Specifically, as illustrated in FIG. 3, the quadrupole unit 23 includes two pairs of opposing electrodes 23P each electrode of which is arranged at an interval of 90°.

In the quadrupole unit 23, after setting the opposing electrodes to the same potential, a voltage applying unit 32, to be described later, applies a voltage resultant of superimposing a high-frequency voltage V cos ωt over a DC voltage U, between each pair of the pairs of electrodes, the pairs being offset with respect of each other by 90°. By using the voltage applying unit 32 to keep the U/V ratio constant while changing V, the quadrupole unit 23 selectively passes the ions becoming incident on the opposing electrodes 23P, based on the mass-to-charge ratio (m/z).

The ion detecting unit 24 is a Faraday cup that captures the ions separated by the quadrupole unit 23, and that detects the ions as an ion current. Specifically, the ion detecting unit 24 detects the ions of a specific component, the component having been separated by the quadrupole unit 23, and detects the absolute value of a partial pressure of the specific component in the sample gas. In addition, the ion detecting unit 24 is also configured to detect the absolute value of the total pressure of the sample gas, by detecting the entire ions of the sample gas ionized by the ionizer unit 21.

As described above, the calculating unit 3 has a calculation processing function and a control function. As illustrated in FIG. 2, the calculating unit 3 includes an amplifier, an A/D converter, a D/A converter, a CPU, a memory, and a communication port. The calculating unit 3 includes a data processing unit 31 that performs mass-spectrometric analysis, based on a value of the ion current output from the ion detecting unit 24 of the sensor unit 2. The data processing unit 31 may also be configured to transmit the analysis result to the general-purpose computer 200 (see FIG. 1), for example, as required.

The calculating unit 3 also functions as a voltage applying unit 32 that applies a voltage resultant of superimposing the high-frequency voltage V cos ωt over the DC voltage U, to the two pairs of opposing electrodes 23P in the quadrupole unit 23, and a control unit 33 that controls the voltage applying unit 32, as illustrated in FIG. 2.

The voltage applying unit 32 applies a voltage resultant of superimposing the high-frequency voltage V cos ωt over the DC voltage U, between each pair of the opposing electrodes 23P each of which is offset by 90°, while changing V in a manner keeping the U/V ratio kept, and is controlled by the control unit 33. The control unit 33 controls the DC voltage U and the high-frequency voltage V cos ωt based on a specific mass-to-charge ratio, and is capable of controlling the voltage applying unit 32, in order to measure a specific mass-to-charge ratio continuously over a predetermined time period, for example.

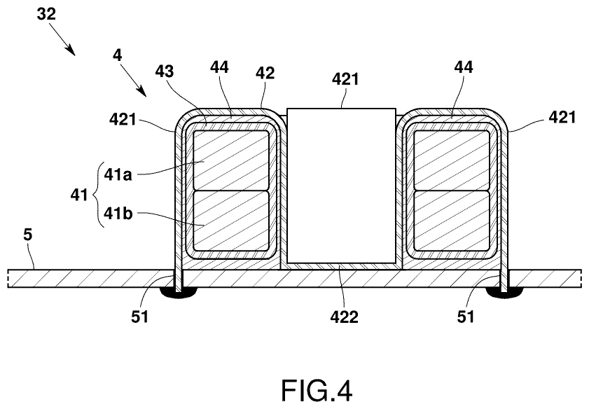

Specifically, as illustrated in FIG. 4, the voltage applying unit 32 includes a transformer 4 for boosting a high-frequency voltage, and is mounted on a high-frequency circuit board 5 for feedback-controlling the high-frequency voltage to a desired voltage.

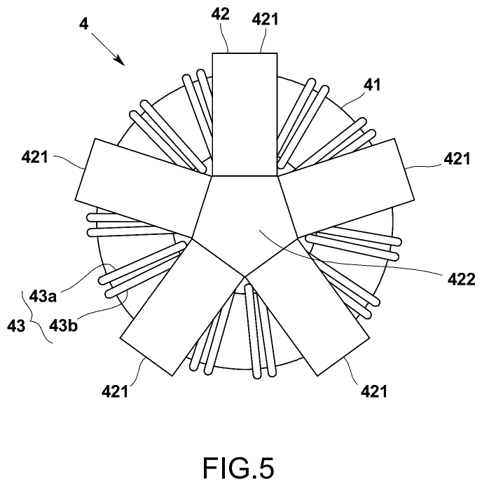

As illustrated in FIGS. 4 and 5, the transformer 4 includes an annular toroidal core 41, and a primary winding 42 and a secondary winding 43 wound around the toroidal core 41, with the primary winding 42 connected to a power supply, and the secondary winding 43 connected to the opposing electrodes. The toroidal core 41 according to the present embodiment has a double structure in which two toroidal core elements 41a and 41b are stacked on top of each other. With this structure, the cross-sectional area of the toroidal core 41 is increased, so that an allowable magnetic flux is increased, and the loss (core loss) in the toroidal core 41, which translates into the heat generated in the toroidal core 41, is reduced.

The primary winding 42 is formed of a plate-like conductor that is made of metal such as copper. The secondary winding 43 is formed of a linear metal conductor. As illustrated in FIG. 5, the secondary winding 43 includes a first secondary winding 43a that is connected to one pair of the two pairs of opposing electrodes 23P, and a second secondary winding 43b that is connected to the other pair of the two pairs of opposing electrodes 23P.

In the transformer 4 according to the present embodiment, the secondary winding 43 is wound around the toroidal core 41 by a predetermined number of turns, and then the primary winding 42 is wound outside of the secondary winding 43. In other words, the secondary winding 43 is wound around of the toroidal core 41 on the inner side, and the primary winding 42 is wound on the outer side. The first secondary winding 43a and the second secondary winding 43b are wound around the toroidal core 41 in a manner following each other, so that variations in magnetic coupling with the primary winding 42 are reduced.

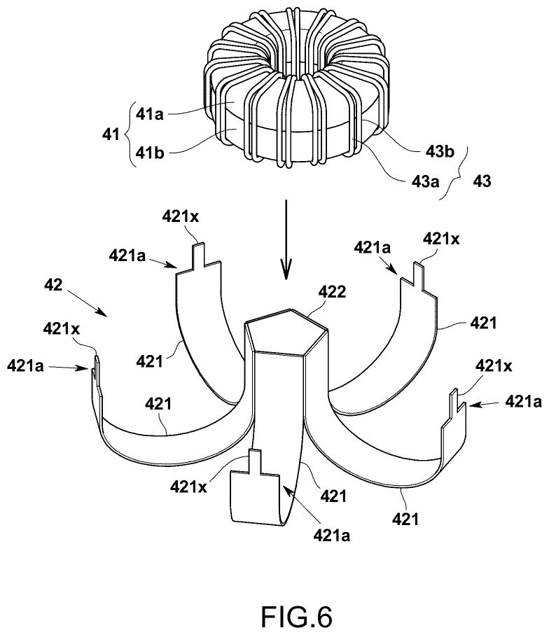

At this time, the primary winding 42 is radially wound around the toroidal core 41 (see FIG. 5). By radially winding the primary windings 42, the cross-sectional area of the primary winding can be increased. Specifically, as illustrated in FIG. 6, the primary winding 42 includes a plurality of belt-shaped portions 421 that are radially positioned in a development view, and the plurality of belt-shaped portions 421 are wound around the toroidal core 41. With this configuration, the primary windings 42 can be radially wound easily.

More specifically, the primary winding 42 has a core portion 422 at the center, and the core portion 422 is disposed at the center of the toroidal core 41. A plurality of belt-shaped portions 421 are disposed in a manner extending radially from the core portion 422. Insertion portions 421x that are to be inserted into respective wiring through-holes 51 (see FIG. 4) of the high-frequency circuit board 5 are provided on respective free ends 421a of the belt-like portion 421.

The transformer 4 is fixed to the high-frequency circuit board 5 by bending the belt-like portions 421 along the outer surface of the toroidal core 41, while inserting the core portion 422 into the center of the toroidal core 41, and by soldering the insertion portions 421x into the respective wiring through holes 51. In other words, the transformer 4 is configured to be fixed to the high-frequency circuit board 5 by fixing the primary winding 42 to the high-frequency circuit board 5. This configuration promotes the dissipation of heat generated by the primary windings 42 to the outside, via the high-frequency circuit board 5, while simplifying the structure for fixing the transformer 4 onto the high-frequency circuit board 5.

Furthermore, in the transformer 4, the space between the toroidal core 41 and the primary winding 42 is filled with an adhesive 44 that is thermally conductive, as illustrated in FIG. 4. This structure promotes transfer of the heat resultant of the loss in the toroidal core 41 (core loss) to the primary winding 42. In addition, the primary winding 42 is connected to the high-frequency circuit board 5. Therefore, the transfer of the heat from the toroidal core to the high-frequency circuit board 5 is prompted via the primary winding 42, so that the heat is better dissipated from the high-frequency circuit board 5 to the outside. In the present embodiment, because the secondary winding 43 is disposed between the toroidal core 41 and the primary winding 42, the secondary winding 43 is surrounded by the adhesive 44.

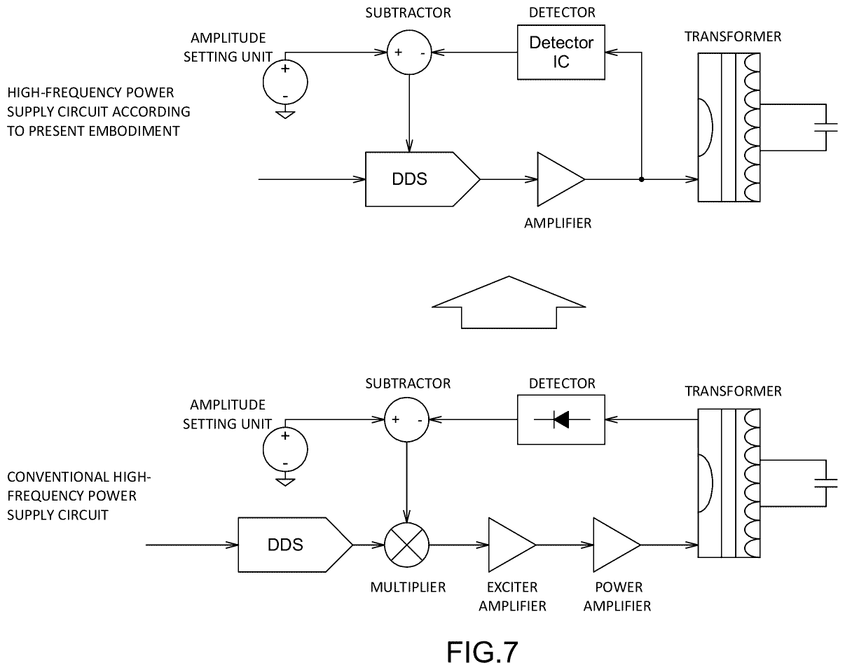

As illustrated in FIG. 7, the high-frequency circuit board 5 according to the present embodiment is provided with a high-frequency power supply circuit for applying a desired high-frequency voltage to the transformer. The diagram on top in FIG. 7 illustrates the high-frequency power supply circuit according to the present embodiment, and the diagram on the bottom in FIG. 7 is a conventional high-frequency power supply circuit.

The conventional high-frequency power supply circuit has a structure with a larger number of components that require the use of high-frequency components. In addition, the high-frequency power supply circuit has a structure using a diode that is temperature-dependent, as a detector of a high-frequency amplitude. Hence, the high-frequency amplitude is greatly affected by the temperature.

By contrast, the high-frequency power supply circuit according to the present exemplary embodiment includes a direct digital synthesizer (DDS), an amplifier that amplifies an output of the DDS, and that outputs the amplified output to a transformer, a detector that detects a high-frequency amplitude from the amplifier, and a subtractor that inputs an amplitude setting signal to the DDS based on a difference between the amplitude detected by the detector and an amplitude setting. A bipolar transistor, instead of the resistor, is then connected to the amplitude setting pin of the DDS (where the current flowing out of the amplitude setting pin changes depending on the resistance connected thereto, and a mirrored current of this current is output to change the high-frequency amplitude), and another circuit is used to change the current flowing out of the amplitude setting pin. By thus changing the high-frequency amplitude output from the DDS, the circuit configuration is simplified.

### Advantageous Effects Achieved by Present Embodiment

With the quadrupole mass spectrometer 100 according to the present embodiment configured as described above, because the transformer 4 includes the toroidal core 41, and the primary winding 42 and the secondary winding 43 that are wound around toroidal core 41, and because the primary winding 42 of the transformer 4 is formed of a metal conductor having a plate-like shape, it is possible to increase the effective cross-sectional area of the primary winding 42 through which the high-frequency current flows. As a result, it is possible to reduce the thermal loss in the primary winding 42, and so that it is possible to reduce the thermal effect attributable to the transformer 4. In addition, because the primary winding 42 is formed of a plate-shaped metal conductor, the number of turns in the primary winding 42 can be reduced. Therefore, it is possible to simplify the winding work, and, hence, to improve the productivity.

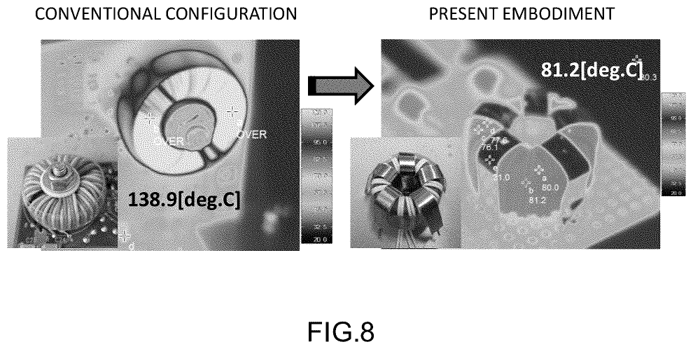

Described below are experimental results in temperatures, on the heat generated in the transformer having the conventional configuration, and in the transformer according to the present embodiment. In the experiments, the frequency of the high-frequency voltage was set to 14 [MHz], and the amplitude of the high-frequency voltage was set to 900 [V]. As illustrated in FIG. 8, while the temperature of the heat generated in the transformer having the conventional configuration was 138.9 degrees, the transformer according to the present embodiment succeeded in suppressing the temperature of the generated heat down to 81.2 degrees.

### Other Embodiments

The primary winding according to the embodiment described above has a configuration in which the plurality of belt-shaped portions are radially provided, as an example, but may also have a configuration including one band-shaped body wound around a toroidal coil in a spiral form.

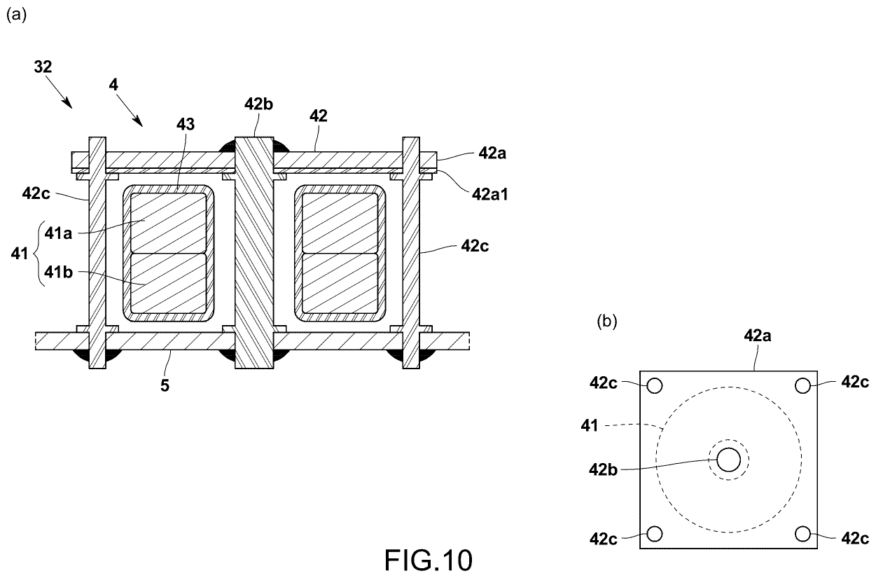

Furthermore, the primary winding 42 may be configured as illustrated in FIG. 10. Specifically, this primary winding 42 includes a base plate 42a that is provided with a metal conductor 42a1 on one surface, a center pin member 42b that is made of a metal conductor, and that is connected to a central portion of the base plate 42a and is disposed at the center of the toroidal core 41, and a plurality of (four, in the explanation herein) peripheral pin members 42c that are made of a metal conductor, and that are connected to respective peripheral portions of the base plate 42a and disposed around the toroidal core 41. The metal conductor 42a1 such as copper foil may be bonded to one surface of the base plate 42a, on the side facing the toroidal core 41. With this configuration, currents flow from the center pin member 42b through the base plate 42a to the plurality of peripheral pin members 42c in radial directions. With such a configuration, the primary winding 42 can be easily assembled.

In the above embodiment, the secondary winding is wound around the toroidal core on the inner side, and the primary winding is wound on the outer side. Alternatively, the primary winding may be wound around the toroidal core on the inner side, and the secondary winding may be wound on the outer side. Still alternatively, the primary winding may be wound around a part of the toroidal core in the circumferential direction, and the secondary winding may be wound around the part other than the part the primary winding is wound, in the circumferential direction.

Furthermore, in the above embodiment, the transformer is fixed to the circuit board by fixing the primary winding to the circuit board, but the transformer may be fixed to the circuit board by another method, e.g., using a fixing screw.

In addition, various modifications and combinations of the embodiment may be made within the scope not deviating from the gist of the present invention.

### INDUSTRIAL APPLICABILITY

According to the present invention, it is possible to reduce the thermal effect of the transformer in a quadrupole mass spectrometer.

1. A quadrupole mass spectrometer comprising:
an ionizer unit that ionizes a sample;
a quadrupole unit that has two pairs of opposing electrodes selectively passing ions generated in the ionizer unit;
a voltage applying unit that applies a voltage obtained by superimposing a high-frequency voltage over a DC voltage to each pair of the two pairs of opposing electrodes; and
an ion detecting unit that detects the ions having passed through the quadrupole unit, wherein
the voltage applying unit includes a transformer that transforms a high-frequency voltage,
the transformer includes a toroidal core, and a primary winding and a secondary winding that are wound around the toroidal core, and
the primary winding is formed of a metal conductor having a plate-like shape.

2. The quadrupole mass spectrometer according to claim 1, wherein the secondary winding wound around the toroidal core includes: a first secondary winding connected to one pair of the two pairs of opposing electrodes; and a second secondary winding connected to another pair of the two pairs of opposing electrodes.

3. The quadrupole mass spectrometer according to claim 1, wherein the toroidal core is configured as a stack of two or more toroidal core elements.

4. The quadrupole mass spectrometer according to claim 1, wherein the primary winding is wound radially around the toroidal core.

5. The quadrupole mass spectrometer according to claim 1, wherein
the primary winding has a plurality of belt-shaped portions that are radially arranged in a development view, and
the plurality of belt-shaped portions are wound around the toroidal core.

6. The quadrupole mass spectrometer according to claim 1, wherein the primary winding comprises:
a base plate that is provided with a metal conductor on one surface;
a center pin member that is made of a metal conductor, and that is connected to a central portion of the base plate and that is disposed at a center of the toroidal core; and
a plurality of peripheral pin members that are connected to a peripheral portion of the base plate, and that includes a metal conductor disposed around the toroidal core.

7. The quadrupole mass spectrometer according to claim 1, wherein a space between the toroidal core and the primary winding is filled with an adhesive having thermal conductivity.

8. The quadrupole mass spectrometer according to claim 1, wherein the transformer is fixed to a circuit board by fixing the primary winding to the circuit board.

9. The quadrupole mass spectrometer according to claim 1, further comprising a control unit that controls the voltage applying unit, wherein
the control unit controls the voltage applying unit to measure a specific mass-to-charge ratio continuously over a predetermined time period.

10. A residual gas analysis method comprising analyzing a residual gas in a vacuum chamber using the quadrupole mass spectrometer according to claim 1.
